(19) United States
(12) Patent Application Publication
(10) Pub. No.: US 2015/0091936 A1
(43) Pub. Date: Apr. 2, 2015

(54) INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventors: Shifeng Peng, Beijing (CN); Xiangyang Li, Beijing (CN); Gaoge Wang, Beijing (CN); Kai Kang, Beijing (CN); Zhixiang Wang, Beijing (CN)

(73) Assignees: Lenovo (Beijing) Co., Ltd., Beijing (CN); Beijing Lenovo Software Ltd., Beijing (CN)

(21) Appl. No.: 14/229,354

(22) Filed: Mar. 28, 2014

(30) Foreign Application Priority Data
Sep. 27, 2013 (CN) 201310452801.7

(51) Int. Cl. G09G 5/37

(52) U.S. Cl. CPC G09G 5/37; G09G 2354/00
USPC 345/590; 345/581

(57) ABSTRACT

The disclosure provides an information processing method and an electronic device. The electronic device includes a display unit and M sensing units, and an operating system and K applications based on the operating system are installed on the electronic device, M and K are positive integers. The method includes: detecting N sensed parameters by N sensing units in the M sensing units, wherein N is an integer greater than or equal to 1 and less than or equal to M; determining an object corresponding to the N sensed parameters; recording the N sensed parameters and the object; and adjusting a display parameter for a display object displayed on the display unit according to the N sensed parameters and object that are recorded.

### CROSS REFERENCE TO RELATED APPLICATION

This application claims priority to Chinese Patent Application No. 201310452801.7, entitled “INFORMATION PROCESSING METHOD AND ELECTRONIC DEVICE”, filed on Sep. 27, 2013 with State Intellectual Property Office of PRC, which is incorporated herein by reference in its entirety.

### FIELD

The disclosure relates to the electronic technology, and particularly to an information processing method and an electronic device.

### BACKGROUND

More and more electronic products emerge with the development of the electronic technology, which brings great convenience to our work and life. For example, by utilizing a cell phone, one may perform voice or video communication, and may also access the Internet for browsing the web pages, downloading data, watching a video and the like.

However, during the process of implementing the technical solutions in embodiments of the disclosure, the inventor finds that an electronic device, after being used by a user, does not record or learn these behaviors, and therefore does not make itself more intelligent through the learning. Therefore, the conventional electronic device has problems of poor learning ability and low intelligence.

### SUMMARY

Embodiments of the disclosure provide an information processing method and an electronic device, for solving the existing technical problem that the electronic device has poor learning ability and low intelligence.

One aspect of the disclosure provides an information processing method applicable in an electronic device, where the electronic device includes a display unit and M sensing units, an operating system and K applications based on the operating system are installed on the electronic device, K and M are positive integers. The method includes: detecting N sensed parameters by N sensing units in the M sensing units, where N is an integer greater than or equal to 1 and less than or equal to M; determining an object corresponding to the N sensed parameters; recording the N sensed parameters and the object; and adjusting a display parameter for a display object displayed on the display unit according to the N sensed parameters and object that are recorded.

Optionally, the display object is adapted for an interaction between a user and the electronic device; and/or the display object is adapted to interact with the object, where the object is a system parameter of the electronic device and/or any of the K applications.

Optionally, a significance of an adjustment of the display parameter and an accuracy of the interaction for the display object increase with an increasing amount of the N sensed parameters and the object that are recorded.

Optionally, the adjusting a display parameter for a display object displayed on the display unit according to the N sensed parameters and object that are recorded includes:

adjusting the shape, the color or a prompt message of the display object according to the N sensed parameters and object that are recorded, where the display parameter includes the shape, the color or the prompt message.

Optionally, after the adjusting a display parameter for a display object displayed on the display unit according to the N sensed parameters and object that are recorded, the method further includes: judging whether the electronic device satisfies a preset condition; and in a case where the electronic device satisfies the preset condition, executing a first operating instruction for the object.

Optionally, after the adjusting a display parameter for a display object displayed on the display unit according to the N sensed parameters and object that are recorded, the method further includes: receiving an input operation via the display object; and executing a second operating instruction for the object based on the input operation.

Another aspect of the disclosure further provides an electronic device on which an operating system and K applications based on the operating system are installed, K and M being positive integers. The electronic device includes a display unit, M sensing units, and a processing unit. The processing unit is adapted to: detect N sensed parameters by N sensing units in the M sensing units, where N is an integer greater than or equal to 1 and less than or equal to M; determine an object corresponding to the N sensed parameters; record the N sensed parameters and the object; and adjust a display parameter for a display object displayed on the display unit according to the N sensed parameters and object that are recorded.

Optionally, the display object is adapted for an interaction between a user and the electronic device; and/or the display object is adapted to interact with the object, where the object is the operating system and/or any of the K applications.

Optionally, a significance of an adjustment of the display parameter and an accuracy of the interaction for the display object increase with an increasing amount of the N sensed parameters and the object that are recorded.

Optionally, the processing unit is adapted to adjust the shape, the color or a prompt message of the display object according to the N sensed parameters and object that are recorded, where the display parameter includes the shape, the color or the prompt message.

Optionally, the processing unit is further adapted to: judge whether the electronic device satisfies a preset condition; and in a case where the electronic device satisfies the preset condition, execute a first operating instruction for the object.

Optionally, the processing unit is further adapted to: receive an input operation via the display object; and execute a second operating instruction for the object based on the input operation.

The one or more technical solutions provided by the embodiments of the disclosure includes at least the following effects or advantages:

in an embodiment of the disclosure, N sensed parameters are detected by N sensing units in M sensing units, where N is an integer greater than or equal to 1 and less than or equal to M; an object corresponding to the N sensed parameters is determined; the N sensed parameters and the object are recorded; and a display parameter for a display object displayed on the display unit is adjusted according to the N sensed parameters and object that are recorded. That is, in the embodiment, an operation of a user on the electronic device, or the environment around the electronic device, or any state change about the electronic device is sensed by the sensing units; then an object corresponding to these sensed parameters is determined, i.e., it is determined which object, for example, an application, is related to these sensed parameters; then the object and the related sensed parameters are recorded, whereby the electronic device learns autonomously; and then the electronic device adjusts a display parameter for a display object displayed on the display unit according to the recorded contents, i.e., the electronic device adjusts the display object on the electronic device according to the contents learned by the electronic device, thereby optimizing the electronic device and improving the service for the user. Therefore, the electronic device in the embodiment can learn and provide service and self-optimization according to the learning, bringing higher intelligence.

Furthermore, in an embodiment of the disclosure, the display object is adapted for an interaction between a user and the electronic device, or the display object is adapted to interact with the object, where the object may be a system parameter of the electronic device or an application based on the operating system. Therefore, in the embodiment, the display object further provides a fast and intelligent interaction interface. For example, the display object may interact with an application on the electronic device according to the recorded content, such as open the application; or the display object may provide a prompt message by utilizing the recorded content, for the usage in the interaction between the user and the electronic device.

Furthermore, in an embodiment of the disclosure, an input operation is received via the display object; and a second operating instruction is executed for the object based on the input operation. For example, in a case where the user clicks on the display object, the object is started directly, or the user is prompted of the state of the object, or a login interface of the object is displayed. Therefore, based on the recorded content, an operating instruction may be directly executed for the object via the display object, further improving the intelligence of the electronic device.

### BRIEF DESCRIPTION OF THE DRAWINGS

FIG. 1 is a flow chart of an information processing method according to an embodiment of the disclosure;

FIGS. 2a to 2c are schematic diagrams of a display object according to an embodiment of the disclosure;

FIGS. 3a and 3b are schematic diagrams of a display object according to another embodiment of the disclosure;

FIGS. 4a to 4b are schematic diagrams showing that a user interacts with an electronic device via a display object according to an embodiment of the disclosure;

FIG. 5 is a schematic diagram showing that a user interacts with an electronic device via a display object according to another embodiment of the disclosure;

FIGS. 6a to 6c are schematic diagrams showing that a display object interacts with an object according to another embodiment of the disclosure; and

FIG. 7 is a functional block diagram of an electronic device according to an embodiment of the disclosure.

### DETAILED DESCRIPTION

Embodiments of the disclosure provide an information processing method and an electronic device, for solving the existing technical problem that the electronic device has poor learning ability and low intelligence.

Technical solutions in the embodiments of the disclosure aim at solving the above technical problem, and the general idea is illustrated as follows.

In an embodiment of the disclosure, N sensed parameters are detected by N sensing units in M sensing units, where N is an integer greater than or equal to 1 and less than or equal to M; an object corresponding to the N sensed parameters is determined; the N sensed parameters and the object are recorded; and a display parameter for a display object displayed on the display unit is adjusted according to the N sensed parameters and the object that are recorded. That is, in the embodiment, an operation of a user on the electronic device, or the environment around the electronic device, or any state change about the electronic device is sensed by the sensing units; then an object corresponding to these sensed parameters is determined, i.e., it is determined which object, for example, an application, is related to these sensed parameters; then the object and the related sensed parameters are recorded, whereby the electronic device learns autonomously; and then the electronic device adjusts a display parameter for a display object displayed on the display unit according to the recorded contents, i.e., the electronic device adjusts the display object on the electronic device according to the contents learned by the electronic device, thereby optimizing the electronic device and improving the service for the user. Therefore, the electronic device in the embodiment can learn and provide service and self-optimization according to the learning, bringing higher intelligence.

To better understand the above technical solution, in the following, the above technical solution will be illustrated in detail in conjunction with the drawings and specific embodiments.

An embodiment of the disclosure provides an information processing method applicable in an electronic device. The electronic device includes a display unit and M sensing units, and an operating system and K applications based on the operating system are installed on the electronic device, where M and K are positive integers. The M sensing units may be a touch screen, a gyroscope, a distance sensor, a light sensor, an accelerometer, a Global Positioning System (GPS) unit, a General Packet Radio Service (GPRS) unit, a receiver, a Near Field Communication (NFC) unit, a camera and the like.

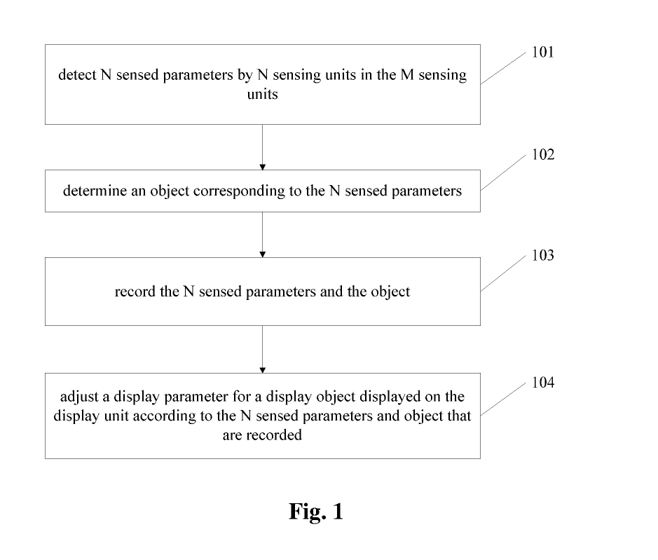

Referring to FIG. 1, an information processing method according to the embodiment is described below. The method includes:

step 101: detecting N sensed parameters by N sensing units in the M sensing units, where N is an integer greater than or equal to 1 and less than or equal to M;

step 102: determining an object corresponding to the N sensed parameters;

step 103: recording the N sensed parameters and the object; and

step 104: adjusting a display parameter for a display object displayed on the display unit according to the N sensed parameters and object that are recorded.

In step 101, the N sensed parameters are detected by N sensing units in the M sensing units. For example, location information of the electronic device is acquired by a GPS unit; the movement is determined by an accelerometer, in which information, such as riding in a car and even the type of the car, may be acquired; the software running on the electronic device is detected by a GPRS unit; an operating trajectory of the user on the electronic device is detected by a touch screen; or environmental information is acquired by a light sensor.

Next, step 102 is performed, in which an object corresponding to the N sensed parameters is determined. For example, in the case that in step 101 the location information of the electronic device is acquired by utilizing the GPS unit, time information in connection with this location, such as the time on the electronic device, is acquired, and the operating trajectory of the user on the electronic device is acquired by the touch screen, then an object corresponding to these sensed information is determined according to these sensed information. For example, it is determined according to the location information that the electronic device is on a moving car; it may be also determined, according to the time information, that the electronic device is on the moving car during this time period; and it is determined according to the operating trajectory that the user has been playing a game. Finally, it is determined that the electronic device runs a game during a time period while being on a car, and then the game is determined as the object. A practice scenario is that, for example, the user goes home by subway between 6:00 to 7:00 PM, and plays a game named “Love Elimination Everyday” on the subway.

For another example, it is detected by the GPRS unit that a ticket for the movie

“Iron Man” is booked through an application “Douban Movie”, it is detected by the time sensing unit that the time is 10:00 AM, and it is detected by the GPRS unit that the electronic device stays at a shopping mall with a cinema for two hours, then it may be determined according to the sensed information that the user sees the movie “Iron Man” at 2:00 PM in the shopping mall, and the activity of seeing a movie is determined as the object.

For another example, between 3:00 to 4:00 PM, it is detected by a gyroscope and an accelerometer that the electronic device remains in a bumpy state, and it is detected by the GPS unit or the GPRS unit that the electronic device moves on a road at a driving speed and stops every distance, then it may be inferred according to the sensed information that the user takes a bus between 3:00 to 4:00 PM, and an activity of taking a bus is determined as the object.

For another example, it is detected by the GPRS unit that the electronic device accesses a news website or a reading website, and it may be detected by the touch screen unit that the electronic device opens a reading software, then it may be determined according to the sensed information that the user likes reading, and books and news may be determined as the object.

For another example, it is detected by the GPRS unit and the touch screen that the electronic device often searches for recipes on the Internet or opens recipes stored on the electronic device, then it may be determined according to the sensed information that the user likes cooking, and a recipe may be determined as the object.

The above description is only illustrative, and in practical applications, the sensed information may also be other information; accordingly, the determined object may also be other objects. In a word, usage information of the electronic device is detected by various sensing units, and an object corresponding to the usage information is determined, for monitoring the behavior of the electronic device and the behavior of the user, to further figure out the habits and requirements of the user.

After the object corresponding to these sensed parameters is determined in step 102, step 103 is performed, in which the N sensed parameters and the object are recorded. The record may be in the form of a table or the like, which is not limited here. In the following, the record in a form of a table is set forth as an example, which can be seen in Table 1.

TABLE 1

| | | | | | | |
|---|---|---|---|---|---|---|
| | Time sensing | | | | GPRS | |
| Touch screen | unit | GPS unit | Gyroscope | . . . | unit | object |

| | | | | | |
|---|---|---|---|---|---|
| A startup | 10:00 to 12:00 AM, | coffee | Portrait | none | A reading |
| operation is | Sep. 20, 2013 | shop A | layout | | software |
| received on | | | | | |
| an icon for a | | | | | |
| reading software | | | | | |
| None | 2:00 to 4:00 PM, | shopping | none | A ticket | Seeing a |
| | Sep. 21, 2013 | mall | | for a | movie |
| | | | | movie is | |
| | | | | purcahsed | |
| A game is started | 6:00 to 7:00 PM, | moving | Portrait | None | A game |
| | Sep. 22, 2013 | | layout | | |
| A file named | 6:00 to 7:00 PM, | residential | none | none | A recipe |
| “recipe” is opened | Sep. 23, 2013 | district | | | |
| A browser is | 12:00 at noon, | building | Portrait | A news | news |
| opened | Sep. 24, 2013 | | layout | website is | |
| | | | | logined | |

In practical applications, it is assumed that Table 1 is blank when the electronic device leaves the factory. Once the electronic device starts to be used, steps 102 and 103 are performed each time some sensed parameters are detected, to record an object and the sensed parameters corresponding to the object in Table 1. As the usage of the electronic device, the records in Table 1 become more and more.

Next, step 104 is performed, in which a display parameter for a display object displayed on the display unit is adjusted according to the N sensed parameters and object that are recorded. Step 104 may include: adjusting the shape, the color or a prompt message of the display object according to the N sensed parameters and object that are recorded, and accordingly, the display parameter includes the shape, the color or the prompt message. In the following, examples are taken to illustrate the above cases respectively.

It is assumed that the display object is in the form of a baby animal or a human baby when the electronic device leaves the factory. As the user uses the electronic device, the baby animal or the human baby grows up, and the direction of growth is related to the usage of the electronic device. Electronic devices may correspond to different users, therefore, even though the display parameters of the display object are the same when the electronic devices leave the factory, the display object on each electronic device may vary gradually, and the variation of the display object may reflect the user habits in using the electronic device and the user preferences.

First, an embodiment of adjusting the shape of the display object is described.

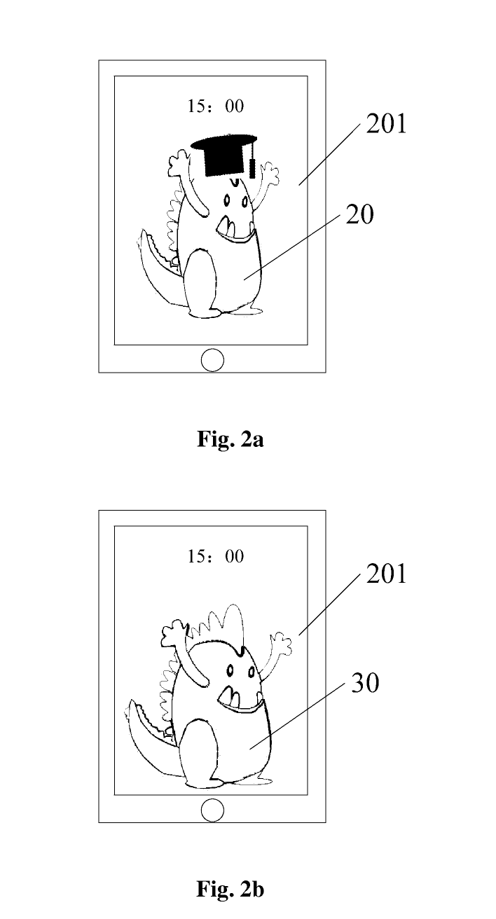

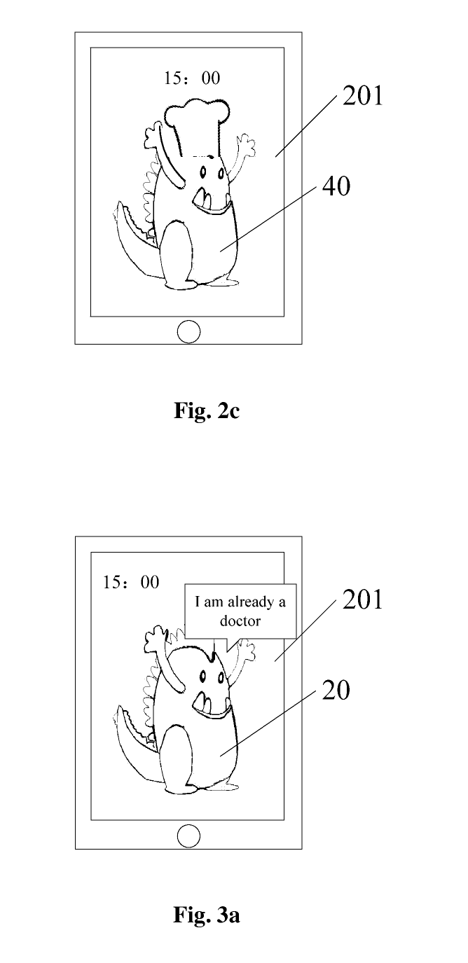

Referring to FIG. 2a, assuming that the object and sensed parameters that are recorded reflect that the occasions or the total time for the book reading and news browsing of the user ranks the first, which indicates that the user likes reading, the display object is adjusted in shape into an image of a doctor. As a result, as shown in FIG. 2a, the display object 20 on the display unit 201 is worn a doctorial hat, thereby becoming the image of a doctor.

For another example, assuming that the object and sensed parameters that are recorded reflect that the user often uses various software to search for restaurants or coupons of restaurants, the appearance of the display object becomes fat. Referring to FIG. 2b, the display object 30 on the display unit 201 becomes fat.

For another example, assuming that the object and sensed parameters that are recorded reflect that the user often uses software to search for recipes or often browses recipes, the appearance of the display object becomes a cooker. As show in FIG. 2c, the display object 40 on the display unit 201 is worn a chef hat, thereby becoming a cooker.

Obviously, each of the display object 20 in FIG. 2a, the display object 30 in FIG. 2b and the display object 40 in FIG. 2c, reflects a stage in the growth process of the display object. The specific image of the display object varies with the recorded content, and the recorded content varies with the behavior of the user. This case is possible: a few months ago, the display object may be of the image in FIG. 2b; while in recent months, the occasions for reading exceeds the times that the user uses the software to search for food, and the image of the display object is changed into the image in FIG. 2a.

In practical applications, the display object may have other images. For example, in a case where the user spends more time in playing game(s), the image of the display object may be changed into a game master, such as an image posturing as in a game; further, in a case where the user often cleans the electronic device, the image of the display object may be adjusted into a clean master, such as an image that wears a clean overalls and takes a broom in hand.

Next, an embodiment of adjusting the color of the display object is described.

In this embodiment, for example, from the object and sensed parameters that are recorded, it is found that the occasions or the total time that the user plays game(s) takes first place, then the display object appears with red eyes, reflecting that the user spends too much time in playing game(s).

For another example, the color of a belt worn on the display object is adjusted according to the object and sensed parameters that are recorded. For example, the color of the belt is originally white, and in a case where it is found from increasing amount of recorded contents that the user spends more and more time in playing game(s), the color of the belt is gradually changed from white to yellow and then to black; and in a case where the amount of records further increases, the appearance of the display object may be adjusted, such as from a student into a warrior, and then the color of the belt is adjusted.

Next, an embodiment of adjusting the prompt message of the display object is described.

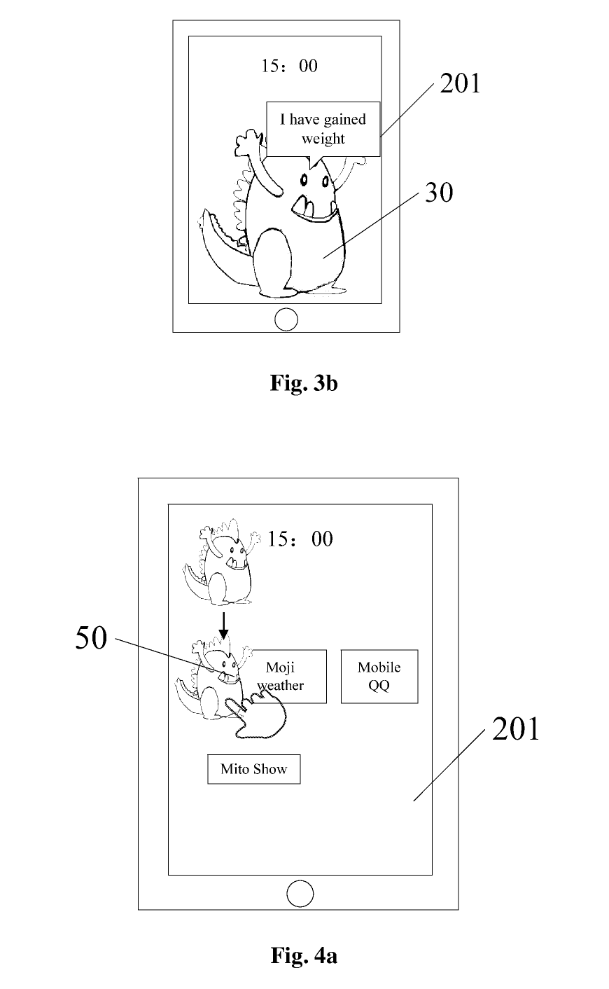

Referring to FIG. 3a, assuming that the object and sensed parameters that are recorded reflect that the occasions or the total time for the book reading and news browsing of the user ranks the first, which indicates that the user likes reading, the prompt message on the display object may be changed into, for example, “I am already a doctor”.

Referring to FIG. 3b, assuming that the object and sensed parameters that are recorded reflect that the user often uses various software to search for restaurants or coupons of restaurants, which indicates that the user is a food-lover, the prompt message on the display object may be changed into, for example, “I have gained weight”.

The above description is only illustrative, and in practical applications, the shape, the color and the prompt message may be adjusted at the same time, or any two of the shape, the color and the prompt message may be adjusted at the same time. Of course, the display parameter may also be other parameters, such as the type. For example, the image of the display object is adjusted from a small animal into a person.

As can be known from the above description, in the embodiment, an operation of the user on the electronic device, or the environment around the electronic device, or any state change about the electronic device is sensed by the sensing units; then an object corresponding to these sensed parameters is determined, i.e., it is determined which object, for example, an application, is related to these sensed parameters; then the object and the related sensed parameters are recorded, whereby the electronic device learns autonomously; and then the electronic device adjusts a display parameter for a display object displayed on the display unit according to the recorded contents, i.e., the electronic device adjusts the display object on the electronic device according to the contents learned by the electronic device, thereby optimizing the electronic device and improving the service for the user. Therefore, the electronic device in the embodiment can learn and provide service and self-optimization according to the learning, bringing higher intelligence.

Furthermore, it also can be seen from the above description that, the significance of the variation of the display parameter increases as the recorded contents increase. For example, the image in FIG. 2b is changed into the image in FIG. 2a. Further, for the image in FIG. 2b, the display object 30 becomes fatter as the recorded contents increase, for example, the image becomes fatter at a speed with a positive acceleration.

In a further embodiment, in addition to changing with the recorded contents, the display object may be further used in the interaction between the user and the electronic device, and/or, the display object may be used to interact with the object, in which the object is a system parameter of the electronic device and/or the K applications.

For the case that the display object is used in the interaction between the user and the electronic device, there may be an active solution and a passive solution. For the passive solution, the user acquires information of an application or a system parameter on the electronic device by operating the display object. For the active solution, the display object provides an operation interface, and the user operates the application or the system parameter on the electronic device by operating the operation interface.

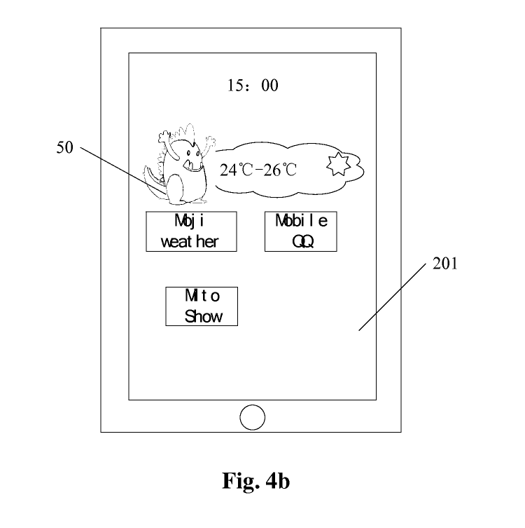

As for the passive solution, a specific example will be illustrated below. Referring to FIG. 4a, a display object 50, and is displayed on the desktop of the display unit 201, and shortcut icons for some applications, such as “Moji weather”, “Mobile QQ” and “Mito Show”, are also displayed on the display unit 201. In a case where the user wants to know the weather, one way is to click to open the application “Moji weather”; while in the embodiment, another way is to drag the display object 50 to the shortcut icon of “Moji weather” with a finger and then release the finger, whereby an interface as shown in FIG. 4b will appear. The display object 50 may prompt the weather condition, for example, that the temperature is 24 to 26 Celsius degrees and it is a sunny day. Further, in addition to the text prompt as shown in FIG. 4b, a voice prompt may also be accompanied, such as “It is a nice day today, the sun is shining, and the temperature is 24 to 26 Celsius degrees”. In the embodiment, the user first operates the display object, to trigger the display object 50 to interact with the application “Moji weather”; and then the weather information is acquired and prompted to the user, thereby completing the interaction between the user and the electronic device.

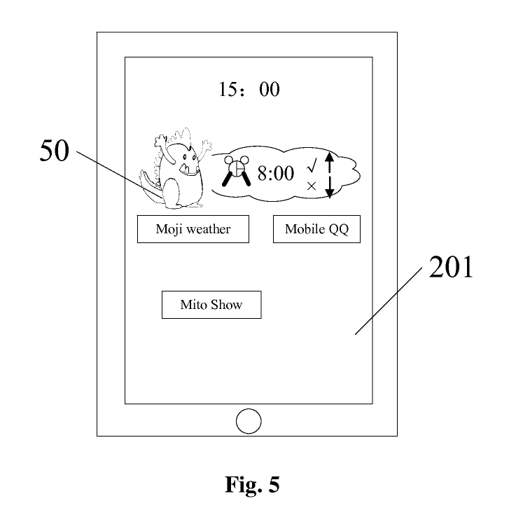

As for the active solution, a specific example will also be illustrated below. Referring to FIG. 5, it is assumed that the user records in an application of notepad that he/she will go out at 9:00 tomorrow morning, then the display object 50 actively generates an operation interface for the user to set an alarm clock according to the recorded content, and may further provides a voice prompt such as “Dear, you have a date at 9:00 tomorrow morning, would you like to be woke up at 8:00 tomorrow morning?” for the user. The operation interface is provided with an alarm time and an operating mode. For example, as shown in FIG. 5, the alarm time is set at 8 o'clock, and an operation prompt is followed for indicating, for example, upward sliding of the operation interface to set the alarm clock and downward sliding of the operation interface to refrain from setting the alarm clock. It is assumed that the user needs to set the alarm clock at this time, the user drags the operation interface to slide upward with a finger, and then the electronic device generates an instruction for setting the alarm clock, and executes the instruction, thereby completing the operation of setting the alarm clock. Accordingly, the user has no need to enter the alarm clock interface to set the alarm clock. Therefore, the way that the user interacts with the electronic device via the display object is very convenient and efficient.

For the case that the display object may be used to interact with the object, there may also be an active solution and a passive solution. For the passive solution, the display object gives a prompt, and only if the user inputs an operation according to the prompt, the display object interacts with the object. For the active solution, the display object interacts with the object directly without participation of the user.

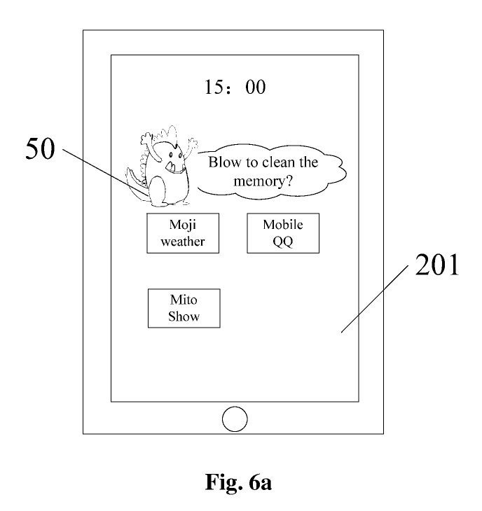

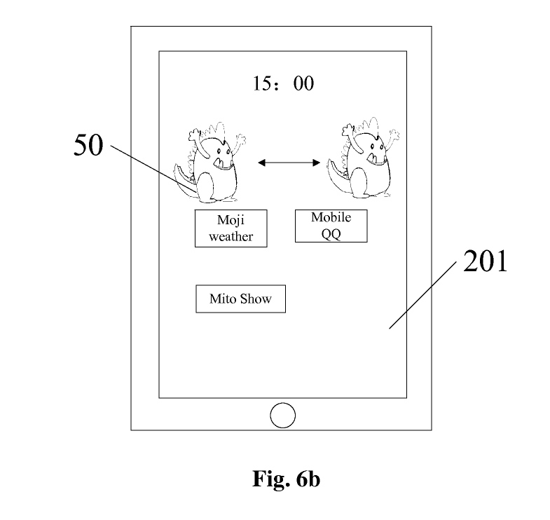

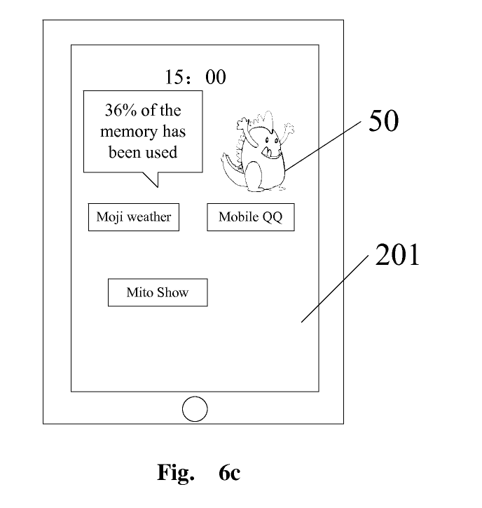

As for the passive solution, a specific example will be illustrated below. Referring to FIG. 6a, according to the memory condition, the display object 50 may, in one aspect, adjust its own image, for example the head may become red and may also sweat in a case where the memory is full; and in another aspect, the display object 50 may also give a prompt, such as a prompt message of “Blow to clean the memory?” in FIG. 6a, which may also be “Shake to clean the memory?” in practical applications, as long as it is convenient for the user to input an operation. Further, a voice prompt may also be accompanied, such as “The memory is full, and I feel dizzy!”. After seeing the prompt, the user may blow onto the electronic device or shake the electronic device, and then the display object 50 may perform an operation of cleaning the memory. As shown in FIG. 6b, in the process of cleaning, the display object 50 may be displayed as running on the display unit 201, indicating that the memory is being cleaned. After the cleaning is completed, as shown in FIG. 6c, the display object 50 further gives a prompt to the user, such as “36% of the memory has been used”.

As for the active solution, a specific example will also be illustrated below. For example, in a case where the display object finds that the memory of the electronic device is full according to the previously recorded content, the display object may directly trigger an operation of cleaning the memory. Further, before and after the cleaning, a voice or text prompt may be used to prompt the user of the operation being performed currently by the display object, but it is not required for the user to participate.

For another example, in a case where the display object finds that the user has a date at 9:00 tomorrow morning according to the recorded content, the display object actively interact with the alarm clock application to complete an operation of setting an alarm clock, for example the alarm clock is set at 8:00 tomorrow morning. After the operation is completed, a voice prompt may be provided to the user, such as “I have set an alarm clock at 8:00 tomorrow morning to wake you up”.

The function of the display object to be involved in an interaction is described above in connection with embodiments illustrating different parties in the interaction. In the following, the function of the display object to be involved in an interaction will be described in connection with embodiments illustrating different modes for the interaction.

For a first interaction mode, after step 104, the method further includes: judging whether the electronic device satisfies a preset condition; and in a case where the electronic device satisfies the preset condition, executing a first operating instruction for the object.

Assuming that the object is the reading software in Table 1, the preset condition is related to the previously recorded content. For example, it is indicated by the record that the user opens the reading software between 10:00 to 12:00 AM everyday, then the preset condition is that the time reaches 10:00 AM; and in a case where it is indicated by the record that the user opens the reading software when taking a bus, the preset condition is that the electronic device is located on a bus. Therefore, accordingly, the judgment of whether the electronic device satisfies the preset condition is a judgment of whether the time reaches 10 o'clock or whether the electronic device is located on a bus; and in a case where the preset condition is satisfied, a first operating instruction is executed for the object.

Executing the first operating instruction includes, for example, displaying a start interface of the reading software, and prompting the user whether to open the reading software; or opening the reading software directly; or opening the reading software and loading the previously read content.

For a second interaction mode, after step 104, the method further includes: receiving an input operation via the display object; and executing a second operating instruction for the object based on the input operation.

Assuming that the object is the reading software in Table 1, in a case where the user touches the display object with a finger, the electronic device receives the input operation via the display object, and then executes a second operating instruction for the object based on the input operation.

Executing the second operating instruction includes: for example, displaying a start interface of the reading software, and prompting the user whether to open the reading software; or opening the reading software directly; or opening the reading software and loading the previously read content. Alternatively, login interfaces of all previously recorded reading software may be displayed around the display object, and the user may select one application interface to enter as required.

Therefore, in the embodiment, according to the recorded content, an operating instruction may be directly executed for the object via the display object, further improving the intelligence of the electronic device.

Obviously, as the recorded content increases, the interaction accuracy of the display object becomes higher. That is because data recorded for one month has higher reliability than data recorded for three days. For example, in the first three days for the recording, the user plays a game A for three times, and plays a game B twice; however, as the recording continues for one month, it is found that the times the user plays the game A is much less than the times the user plays the game B. Therefore, in a case where the interaction is performed after one month, the display object opens the game B rather than the game A, and the interaction accuracy is improved accordingly.

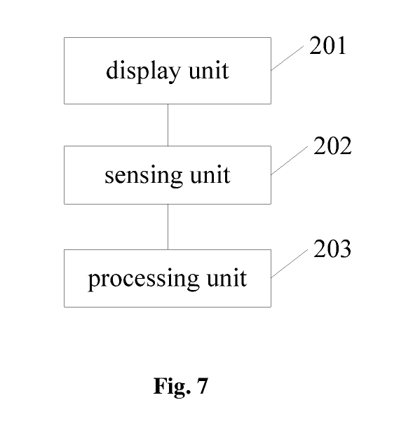

Based on the same inventive concept, an embodiment of the invention further provides an electronic device on which an operating system and K applications based on the operating system are installed, K and M being positive integers. As shown in FIG. 7, the electronic device includes: a display unit 201; M sensing units 202; and a processing unit 203. The processing unit 203 is adapted to: detect N sensed parameters by N sensing units 202 in the M sensing units 202, where N is an integer greater than or equal to 1 and less than or equal to M; determine an object corresponding to the N sensed parameters; record the N sensed parameters and the object; and adjust a display parameter for a display object displayed on the display unit 201 according to the N sensed parameters and object that are recorded.

In an embodiment, the display object is adapted for an interaction between a user and the electronic device; and/or the display object is adapted to interact with the object, where the object may be a system parameter of the electronic device and/or the K applications.

Further, a significance of an adjustment of the display parameter and an accuracy of the interaction for the display object increase with an increasing amount of the N sensed parameters and the object that are recorded.

In an embodiment, the processing unit 203 is adapted to adjust the shape, the color or a prompt message of the display object according to the N sensed parameters and object that are recorded, in which case the display parameter includes the shape, the color or the prompt message.

In an embodiment, the processing unit 203 is further adapted to: judge whether the electronic device satisfies a preset condition; and in a case where the electronic device satisfies the preset condition, execute a first operating instruction for the object.

In another embodiment, the processing unit 203 is further adapted to: receive an input operation via the display object; and execute a second operating instruction for the object based on the input operation.

In the above embodiments, the M sensing units 202 may include a touch screen, a gyroscope, a distance sensor, a light sensor, an accelerometer, a GPS unit, a GPRS unit, a receiver, a NFC unit, a camera and the like.

The electronic device may further include other elements, such as a memory for storing data needed for the processing unit 203, or a user interface for connecting an external device, such as an earphone and a sound box.

Various variations and specific examples of the information processing method according to the embodiment described above in FIG. 1 may also apply to the electronic device of this embodiment. With the detailed description of the above information processing method, those skilled in the art may clearly understand the implementation of the electronic device in this embodiment, which is not repeated here for conciseness of the specification.

The one or more technical solutions provided by the embodiments of the disclosure include at least the following effects or advantages.

In an embodiment of the disclosure, N sensed parameters are detected by N sensing units in M sensing units, where N is an integer greater than or equal to 1 and less than or equal to M; an object corresponding to the N sensed parameters is determined; the N sensed parameters and the object are recorded; and a display parameter for a display object displayed on the display unit is adjusted according to the N sensed parameters and object that are recorded. That is, in the embodiment, an operation of a user on the electronic device, or the environment around the electronic device, or any state change about the electronic device is sensed by the sensing units; then an object corresponding to these sensed parameters is determined, i.e., it is determined which object, for example, an application, is related to these sensed parameters; then the object and the related sensed parameters are recorded, whereby the electronic device learns autonomously; and then the electronic device adjusts a display parameter for a display object displayed on the display unit according to the recorded contents, i.e., the electronic device adjusts the display object on the electronic device according to the contents learned by the electronic device, thereby optimizing the electronic device and improving the service for the user. Therefore, the electronic device in the embodiment can learn and provide service and self-optimization according to the learning, bringing higher intelligence.

Furthermore, in an embodiment of the disclosure, the display object is adapted for the interaction between the user and the electronic device, or the display object is adapted to interact with the object, where the object may be a system parameter of the electronic device or an application based on the operating system. Therefore, in the embodiment, the display object further provides a fast and intelligent interaction interface. For example, the display object may interact with an application on the electronic device according to the recorded content, such as open the application; or the display object may provide a prompt message by utilizing the recorded content, for the usage in the interaction between the user and the electronic device.

Furthermore, in an embodiment of the disclosure, an input operation is received via the display object; and a second operating instruction is executed for the object based on the input operation. For example, in a case where the user clicks on the display object, the object is started directly, or the user is prompted of the state of the object, or a login interface of the object is displayed. Therefore, based on the recorded content, an operating instruction may be directly executed for the object via the display object, further improving the intelligence of the electronic device.

It should be understood by those skilled in the art that, the embodiments according to the present disclosure may be implemented as a method, system or computer program product. Hence, the embodiments of the invention may be implemented with hardware only, with software only, or with a combination of hardware and software. Furthermore, the embodiments of the present disclosure may be implemented in computer program products in the form of computer readable media (including but not limited to magnetic disk storages, optical storages, etc.) storing computer executable codes.

The description in this disclosure is made in conjunction with flowchart(s) and/or block diagram(s) of the method, device (system) or computer program product according to the embodiments of the disclosure. It should be understood that each process in the flowchart and/or each block in the block diagram and any combination of processes and/or blocks in the flowchart and/or the block diagram may be implemented through computer program instructions. The computer instructions may be provided to a processor of a general-purpose computer, dedicated computer, embedded processing machine or any other programmable data processing device to achieve a machine, in which device(s) to implement functions specified in one or more processes of the flowchart and/or one or more blocks of the block diagram is(are) achieved through executing the instructions by the computer or any other programmable data processing device.

The computer program instructions may further be stored in a computer readable storage which may lead the computer or any other programmable data processing device to operation in particular manner in order that a product including an instruction device is generated according to the instructions stored in the computer readable storage, where the instruction device is configured to implement the functions specified in one or more processes of the flowchart and/or one or more blocks of the block diagram.

The computer program instructions may further be loaded to the computer or any other programmable data processing device in order that a series of steps are executed on the computer or any other programmable data processing device to generate processes implemented by the computer, and the steps to implement the functions specified in one or more processes of the flowchart and/or one or more blocks of the block diagram are provided by the instructions executed on the computer or any other programmable data processing device.

Obviously, various changes and modifications can be performed on the disclosure by those skilled in the art without departing from the spirit and scope of the disclosure. The invention intends to include those changes and modifications within the scope of the claims of the invention and equivalents thereof.

1. An information processing method applicable in an electronic device, wherein the electronic device comprises a display unit and M sensing units, an operating system and K applications based on the operating system are installed on the electronic device, K and M are positive integers, the method comprises:
detecting N sensed parameters by N sensing units in the M sensing units, wherein N is an integer greater than or equal to 1 and less than or equal to M;
determining an object corresponding to the N sensed parameters;
recording the N sensed parameters and the object; and
adjusting a display parameter for a display object displayed on the display unit according to the N sensed parameters and object that are recorded.

2. The method according to claim 1, wherein the display object is adapted for an interaction between a user and the electronic device; and/or
the display object is adapted to interact with the object, wherein the object is a system parameter of the electronic device and/or any of the K applications.

3. The method according to claim 2, wherein a significance of an adjustment of the display parameter and an accuracy of the interaction for the display object increase with an increasing amount of the N sensed parameters and the object that are recorded.

4. The method according to claim 1, wherein the adjusting a display parameter for a display object displayed on the display unit according to the N sensed parameters and object that are recorded comprises:
adjusting a shape, a color or a prompt message of the display object according to the N sensed parameters and object that are recorded, wherein the display parameter comprises the shape, the color or the prompt message.

5. The method according to claim 1, wherein after the adjusting a display parameter for a display object displayed on the display unit according to the N sensed parameters and object that are recorded, the method further comprises:
judging whether the electronic device satisfies a preset condition; and
in a case where the electronic device satisfies the preset condition, executing a first operating instruction for the object.

6. The method according to claim 1, wherein after the adjusting a display parameter for a display object displayed on the display unit according to the N sensed parameters and object that are recorded, the method further comprises:
receiving an input operation via the display object; and
executing a second operating instruction for the object based on the input operation.

7. An electronic device, wherein an operating system and K applications based on the operating system are installed on the electronic device, K is a positive integer, the electronic device comprises:
a display unit;
M sensing units, wherein M is a positive integer; and
a processing unit, used to detect N sensed parameters by N sensing units in the M sensing units, N being an integer greater than or equal to 1 and less than or equal to M; to determine an object corresponding to the N sensed parameters; to record the N sensed parameters and the object; and to adjust a display parameter for a display object displayed on the display unit according to the N sensed parameters and object that are recorded.

8. The electronic device according to claim 7, wherein the display object is adapted for an interaction between a user and the electronic device; and/or the display object is used to interact with the object, wherein the object is a system parameter of the electronic device and/or any of the K applications.

9. The electronic device according to claim 8, wherein a significance of an adjustment of the display parameter and an accuracy of the interaction for the display object increase with an increasing amount of the N sensed parameters and the object that are recorded.

10. The electronic device according to claim 7, wherein the processing unit is adapted to adjust a shape, a color or a prompt message of the display object according to the N sensed parameters and object that are recorded, wherein the display parameter comprises the shape, the color or the prompt message.

11. The electronic device according to claim 7, wherein the processing unit is further adapted to: judge whether the electronic device satisfies a preset condition; and in a case where the electronic device satisfies the preset condition, execute a first operating instruction for the object.

12. The electronic device according to claim 7, wherein the processing unit is further adapted to: receive an input operation via the display object; and execute a second operating instruction for the object based on the input operation.
